(19) United States
(12) Patent Application Publication
(10) Pub. No.: US 2003/0075890 A1
(43) Pub. Date: Apr. 24, 2003

(54) Magnetic skateboard attachment system

(76) Inventor: Robert A. Jacobs, Campbell, CA (US)

Correspondence Address: LEARY & ASSOCIATES, 3900 NEWPARK MALL RD., THIRD FLOOR, SUITE 317, NEWARK, CA, 94560, US

(21) Appl. No.: 10/011,328

(22) Filed: Oct. 22, 2001

(51) Int. Cl. B62M 1/00

(52) U.S. Cl. 280/87.042

(57) ABSTRACT

A skateboard having ferrous metal plates inlaid into the top surface is attracted to magnet housing assemblies embedded in the soles of the rider's shoes. The magnet housing assemblies increase the strength of the magnets housed within them to a point sufficient enough to overcome the strong G forces induced from the sudden upward thrust of the rider's legs during an airborne maneuver. The ferrous metal plates are positioned such that if the skateboard is flipped end for end, the magnet housing assemblies embedded in the shoes will no longer align with the ferrous metal plates and the skateboard can be used as a conventional non-magnetic skateboard.

### FIELD OF THE INVENTION

This invention relates to skateboards, and more particularly to a skateboard that remains magnetically held against the riders shoes while the rider is performing maneuvers on the skateboard.

### BACKGROUND OF THE INVENTION

Skateboards have been in existence for many years, but in recent years skateboard maneuvers have become more intricate and precise and demand a greater level of control over the board. Some of today's more advanced maneuvers require the rider and board to become airborne. Since control inputs for the skateboard are transmitted through the rider's feet, a problem arises when both the rider and board become airborne. Since there is no reactive gravitational force holding the board against the rider's feet during the airborne portion of the maneuver, there is the danger of injury due to an uncontrolled landing. Currently there is no good method for keeping the board in contact with the rider's feet. Skateboard riders have tried different solutions to solve this problem such as crouching and grabbing the board with one hand before becoming airborne. This solution is undesirable because it leaves the rider in a precarious and unstable position before and during the airborne maneuver. It also exposes the rider's fingers to injury during some types of maneuvers.

Prior art skateboards, such as U.S. Pat. No. 4,179,134 to Atkinson, provide a rigid removable trainer handle and brake apparatus. U.S. Pat. No. 4,289,325 to Whitacre provides a flexible cord that attaches to the front of the board. Both U.S. Pat. No. 4,887,825 to Mason et al. and U.S. Pat. No. 5,221,111 to Younger provide flexible cords that attach to the center of the board. All have the same disadvantage in that they require the use of the rider's hands to hold the board against the rider's feet. This is insufficient for today's advanced skateboard maneuvers, which require that the rider's hands and arms are free to be used for balance and stability.

Another prior art skateboard, U.S. Pat. No. 5,769,438 to Svetlov, describes a skateboard with magnets embedded in the surface, approximately at the center of the skateboard and magnets embedded in the soles of the rider's shoes. When the rider aligns the magnets in soles of the shoes with the magnets embedded in the center of the skateboard, the skateboard becomes magnetically attached to the rider's feet. This method has three disadvantages. The first being that even the strongest magnets currently available that can efficiently fit in the sole of a shoe, such as neodymium-iron-boron magnets, cannot by themselves provide the strength required to adequately hold the skateboard to the rider's feet throughout most modern skateboard maneuvers. For a skateboard to remain attached to a rider's feet throughout an airborne maneuver, the bond between the skateboard and the rider's shoe not only has to overcome the weight of the skateboard, but it must also overcome the strong G force induced from the sudden upward thrust of the rider's legs. This means that the magnets must overcome many times the static weight of the skateboard.

The second disadvantage of the above-mentioned patent is that the magnets embedded in the soles of the shoes must remain exactly aligned with the magnets embedded in the center of the skateboard. This does not allow the rider the slight repositioning of the feet required by most skateboard maneuvers to maintain balance and control.

The third disadvantage is the position of the magnets embedded at the center of the skateboard. In this configuration, for a rider to stay securely coupled to the skateboard, both feet must be placed at the center of the skateboard as opposed to the standard positioning of the feet where one foot is on the tail and the other is approximately over the front wheels. Requiring a rider to keep both feet at the center of the skateboard would make most skateboard maneuvers extremely difficult if not impossible to perform.

### SUMMARY OF THE INVENTION

The present invention uses a specially designed skateboard with 2 thin ferrous metal plates inlaid into the top surface of the body of the skateboard. These thin ferrous metal plates are attracted to magnet housing assemblies embedded in the soles of the rider's shoes. The magnet housing assemblies, by nature of their geometry and material, increase the strength of the magnets housed within them to a point sufficient to overcome the strong G forces induced from the sudden upward thrust of the rider's legs during an airborne maneuver. The increased magnetic strength of the magnet-housing-assemblies, keeps the skateboard firmly attached to the rider's feet giving the rider better control, stability and confidence throughout the airborne maneuvers. The size and position of the inlaid ferrous metal plates with respect to the magnet housing assemblies embedded in the soles of the riders shoes allows the rider to use the standard positioning and movement of the feet that is required by most skateboard maneuvers. The present invention also allows the rider full use of the hands and arms for balance and stability rather than for holding the board to the feet throughout airborne maneuvers.

The ferrous metal plates are also positioned in such a way that if the skateboard is flipped end for end, the magnet housing assemblies embedded in the shoes will no longer align with the ferrous metal plates and the skateboard can be used as a conventional non-magnetic skateboard. In this non-magnetic configuration, the rider can perform maneuvers that require the skateboard to be detached from the rider's feet.

### BRIEF DESCRIPTION OF DRAWINGS

FIG. 1 is a perspective exploded view of a magnetic skateboard in accordance with the present invention.

FIG. 2A is a perspective view of the magnet housing assembly.

FIG. 2B is a perspective exploded view of the magnet housing assembly.

FIG. 3A is a perspective exploded view of the specially molded rubber sole including the magnet housing assembly.

FIG. 3B is a perspective view of the bottom face of the specially molded rubber sole.

FIG. 4A is a perspective view of the placement of the specially molded rubber soles on the magnetic skateboard.

FIG. 4B & 4C are sectional views of the magnet housing assembly sitting on the thin ferrous metal plates.

FIG. 5 is a perspective view of the placement of the specially molded rubber soles on the magnetic skateboard in the non-magnetic configuration.

FIG. 6 is a view of the magnetic attachment used on a snowboard.

FIG. 7 is a view of the magnetic attachment used on a mountain board.

### REFERENCE NUMERALS IN DRAWINGS

1 Skateboard Deck

2 Circular Milled Cavity

3 Oval Shaped Milled Cavity

4 Circular Ferrous Metal Plate

5 Oval Shaped Ferrous Metal Plate

6 Front Truck Screw

7 Wood Screw

8 Magnet Housing Assembly

9 Specially Molded Rubber Sole

10 Oval Shaped Base Plate

11 Circular Steel Pole Pieces

12 Neodymium Iron Boron Magnet

13 Rivet

14 Shallow Oval Shaped Relief

15 Circular Holes

16 Bottom Face of Sole

### DETAILED DESCRIPTION

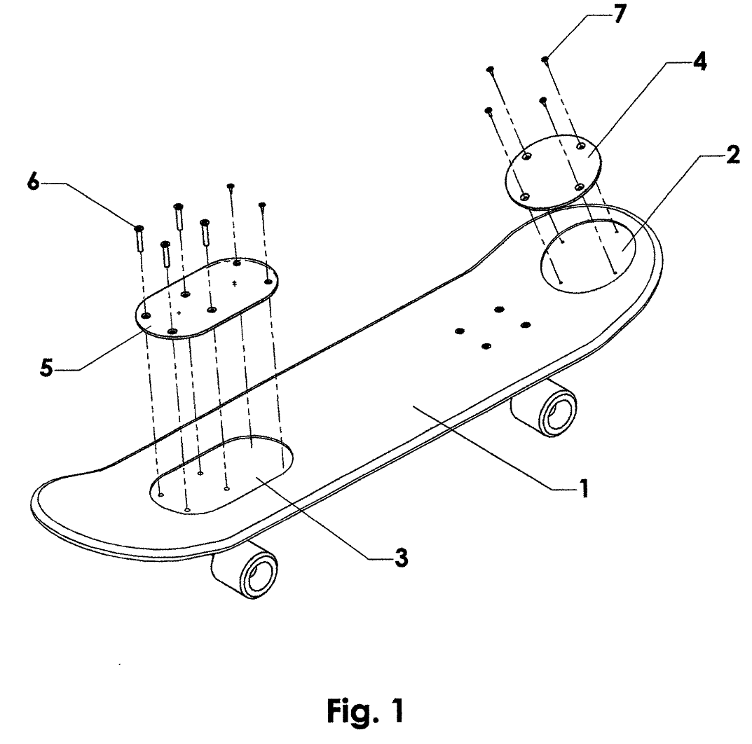

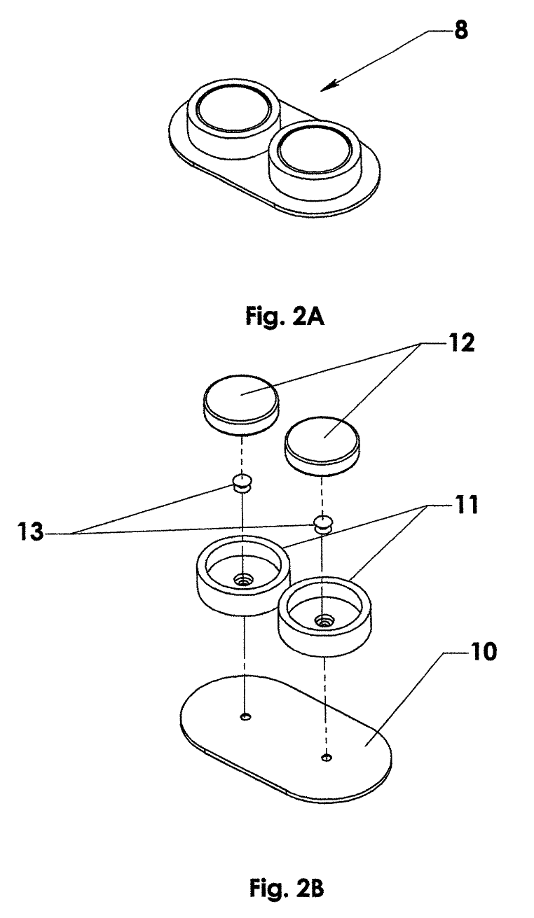

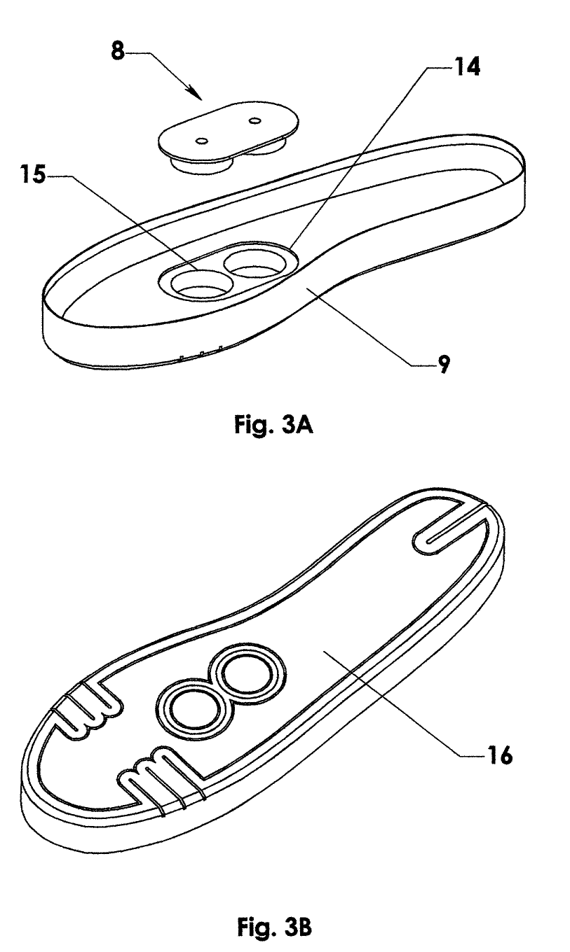

A preferred embodiment of the present invention is illustrated in FIGS. 1, 2A, 2B, 3A, 3B, 4A, 4B, 4C and 5. FIG. 1 shows an exploded view of a skateboard with a specially designed skateboard deck 1. The deck has a circular milled, molded or otherwise formed cavity 2 in the rear and an oval shaped cavity 3 in the front. Into these milled cavities a circular ferrous metal plate 4 and an oval shaped ferrous metal plate 5 are fastened using any desired attachment mechanism, such as adhesive, nails, screws, etc. In the embodiment shown, four front truck screws 6 and six wood screws 7 are used. In the preferred embodiment, the skateboard deck is comprised of laminated maple layers, however, any other wood, plastic or laminated fibrous materials could be used. The circular and oval shaped ferrous metal plates 4, 5 act as a means to secure the skateboard deck 1 to the riders feet by attracting a magnet housing assembly 8, shown in FIG. 2A, embedded in a specially molded rubber sole 9, shown in FIG. 3A, of the rider's shoe.

FIGS. 2A, 2B, 3A and 3B show the preferred embodiment of the specially molded rubber sole 9 and the magnet housing assembly 8 of the skateboard rider's shoe(s). The magnet housing assembly 8, shown in FIGS. 2A & 2B, has a base plate 10, steel pole pieces 11, two magnets 12, and two rivets 13. The base plate 10 may be anywhere from 0.5 to 3.0 inches wide, more preferably between 1.0 and 2.5 inches wide, and most preferably between 1.5 and 2.25 inches wide. The base plate 10 may be anywhere from 0.5 to 5.0 inches long, more preferably between 1.5 and 4.0 inches long, and most preferably between 2.5 and 3.5 inches in length. The thickness of the plate 10 may be anywhere from 0.02 to 0.25 inches, more preferably between 0.03 and 0.125 inches, and most preferably between 0.04 and 0.9. The base plate 10 shown is and elongated oval approximately 1.75 inch wide by 3.15 inches long and having a thickness of 0.047 inch. In other embodiments, other sizes and shapes of plates 10 may be used. For example, if a single circular magnet 12 and pole 11 is used, the plate may be round. If three magnets 12 are used, then the plate might be a triangle with or without rounded comers. Four magnets 12 might use a round, square or diamond shape depending on the orientation of the magnets 12 and the holding force needed. In other embodiments, the plate might be omitted entirely. In this case, the pole piece would be adhered directly to the shoe or an interlocking lip might be used to hold the pole piece in place.

In the preferred embodiment, two circular pole pieces 11 are fastened to the base plate 10 using solid rivets at the center of the circular pole pieces 11. The rivet may attach the pieces tightly together to inhibit movement between the base plate 10 and the pole pieces 11, or the rivet may be fit loosely to allow the pole piece 11 to pivot slightly with respect to the base plate 10, thereby allowing the pole piece 11 to align with the skateboard deck 1. In other embodiments the pieces 10, 11 may be connected by any other type of secure attachment mechanism, such as adhesive, nut and bolt, resistance spot welds, etc. In the current embodiment, the pole pieces 11 are cups formed of steel, iron or other ferrous material. The pole pieces 11 have an outer diameter anywhere between 0.5 and 2.0 inches, more preferably between 0.75 and 1.5 inches, and most preferably between 1.0 and 1.4 inches. The thickness of the wall of the pole 11 may be anywhere between 0.05 to 0.5 inches, more preferably between 0.07 and 0.4 inches, and most preferably between 0.1 and 0.15 inches. The pole 11 has a depth in the range of 0.1 to 0.75 inches, more preferably between 0.15 and 0.5 inches, and most preferably between 0.2 and 0.4 inches. In the embodiment shown, the cup has an outside diameter of approximately 1.25 inch, a wall thickness of 0.125, and a depth of 0.25 inches.

The magnets 12 are inserted into the circular pole pieces 11 and held in position by way of the magnetic attraction between the magnets 12 and the pole pieces 11. The magnets 12 are sized to fit closely within the cavity formed by the pole piece 11. Although other magnets may be used, currently the magnets are neodymium-iron-boron. The magnets 12 are inserted such that one magnet has polar north facing outward and the other magnet has polar south facing outward. This orientation of the magnets assures that the magnets do not repel one another when the rider steps on the ferrous metal plates 4, 5 of the skateboard deck 1.

The magnet housing assembly 8 is inserted and cemented into the shallow oval shaped relief 14 and circular holes 15, shown in FIG. 3A, of the specially molded rubber sole 9. The thickness of the rubber sole 9 is such that the face of the neodymium-iron-boron magnets 12 and the rim of the steel pole pieces 11 are flush with the bottom face 16 of the rubber sole, as seen in FIG. 3B. The upper side of specially molded rubber sole 9 is shaped such that it can be cemented, using conventional shoe manufacturing techniques, to a standard athletic shoe upper assembly made of a leather, canvas or polymer material. In alternate embodiments, the sole may be attached to the user's foot or current shoe with other attachment systems. In this case, the sole may be a flat piece that has straps and buckles, hook and loop fastener, etc. extending out the sides to wrap around the foot and/or shoe of the user. Although not necessary, it may provide additional security if a band of the sole extends between the poles of the magnet housing assembly 8, as shown.

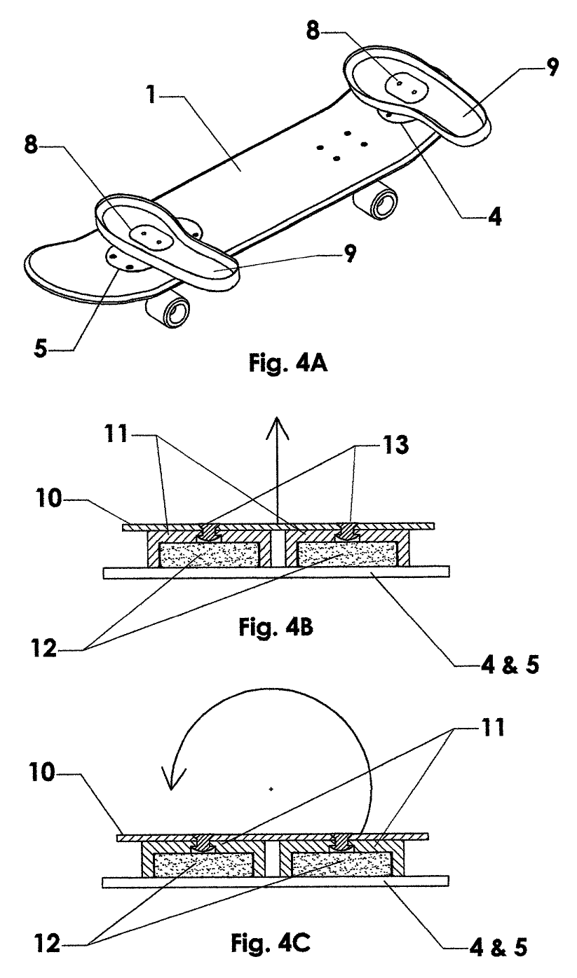

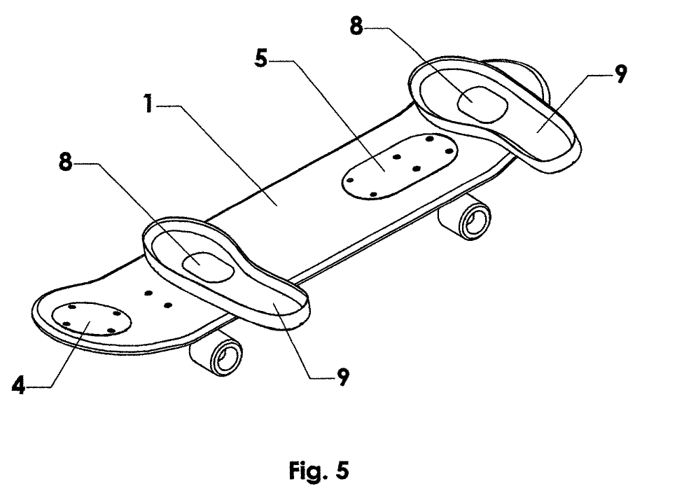

The positions of the ferrous metal plates 4, 5, in the preferred embodiment of the magnetic skateboard, are such that the rider's feet can be placed in the same standard riding positions as that of any conventional skateboard, as illustrated in FIGS. 4A, 4B and 4C. The front plate 5 is located such that the front edge of the plate may be anywhere between 0and 10.0 inches from the front edge of the skateboard deck 1, more preferably between 3.0 and 7.0 inches, and most preferably between 4.0 and 6.0 inches. The front plate 5 may be of any suitable size, such as in the range of 1.0 by 2.0 inches to 6.0 by 18.0 inches, more preferably between 2.0 by 3.0 inches and 5.0 by 12.0 inches, and most preferably between 3.0 by 6.0 inches and 4.0 by 10.0 inches. The thickness of the front plate 5 is in the range of 0.01 inches to 1.0 inch, more preferably between 0.05 and 0.5 inches, and most preferably between 0.1 and 0.25 inches. In the embodiment shown, the front plate 5 is an elongated oval shape with the width at maximum of approximately 3.5 inches, length 6.5 inches and a thickness of 0.104 inch. The front plate 5 may extend up into the upturned portion of the skateboard deck 1, if desired.

In most cases, the rear plate 4 is closer to the end of the skateboard deck 1. The rear plate 4 may have its rear edge anywhere from 0 and 5.0 inches from the back edge of the skateboard deck 1, more preferably between 0.1 and 3.0 inches, and most preferably between 0.25 and 2.0 inches. The rear plate 4 may be of any suitable size, such as in the range of 1.0 by 2.0 inches to 7.0 by 18.0 inches, more preferably between 2.0 by 3.0 inches and 6.0 by 12.0 inches, and most preferably between 3.0 by 6.0 inches and 5.0 by 10.0 inches. The thickness of the rear plate 4 is in the range of 0.01 inches to 1.0 inch, more preferably between 0.05 and 0.5 inches, and most preferably between 0.1 and 0.25 inches. In the embodiment shown, the rear plate 4 is round with a diameter of approximately 4.0 inches and a thickness of 0.104 inch. The rear plate 4 may extend up into the horizontal portion of the skateboard deck 1, if desired.

The sole 9 of one shoe is placed approximately over the circular ferrous metal plate 4 in the tail of the magnetic skateboard deck 1. The sole 9 of the other shoe is placed approximately over the oval shaped ferrous metal plate 5 in the front of the skateboard deck 1. With the rider's feet in the standard riding position, the magnet housing assemblies 8 embedded in the soles 9 are positioned over the ferrous metal plates 4, 5. The sizes and shape of the ferrous metal plates 4, 5 are such that the magnet housing assemblies 8 do not have to be positioned exactly over the plates. This allows the rider the ability to shift foot position while riding allowing better stability and control. With the rider's feet in the standard riding position, the magnetic flux from the inner facing poles of the magnets 12, as seen in FIG. 4B, is focused through the steel pole pieces 11, around the outer surface of the magnets 12, through the ferrous metal plates 4, 5 and back into the opposite outward facing poles of the magnets 12, to make a complete magnetic circuit. This magnetic circuit created by the magnet housing assembly provides a holding force much greater than that which could be provided by the magnets alone. This is because the individual magnets 12 cannot carry the high fluxes that the steel pole pieces 11 can. Therefore, the steel pole pieces 11 focus the magnetic flux so that the flux per unit area at the contact point of ferrous metal plates 4, 5 is higher than the flux per unit area at the interface between magnets 12 and pole pieces 11. It is through the use of the magnet housing assemblies 8 that the skateboard deck 1 can remain securely attached to the rider's shoes as the shoes are thrust vertically upward during an airborne skateboard maneuver. Far less force is required to break the magnetic circuit if a rotational force is applied to the magnet housing assembly 8, as shown in FIG. 4C. A rider can assert this rotational force by rotating the shoe heel over toe and bending at the ball of the foot. It is in this way that the rider can detach from the board at will, such as when one foot is needed to propel the skateboard forward or the rider needs to get clear of the board for safety reasons.

As can be seen in FIG. 5, ferrous metal plates 4, 5 are also positioned so that when the skateboard is flipped end for end the magnet housing assemblies 8, embedded in the soles 9 of the rider's shoes, no longer align with the ferrous metal plates 4, 5. This allows the rider to easily switch from a magnetic skateboard configuration to a conventional skateboard configuration for maneuvers that do not require magnetic attachment. The board may be symmetrical or asymmetrical depending on the preference of the user. If the user is likely to switch the board between magnetic and non-magnetic direction, the board is preferably symmetrical. If the user is unlikely to switch, the board may be asymmetrical, if preferred. The entire skateboard deck 1 may be flat and horizontal, or the ends may be upturned as shown.

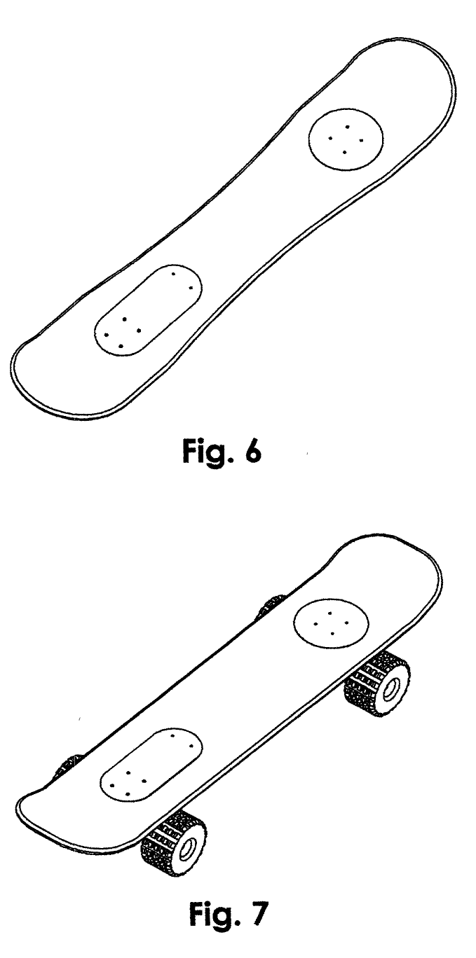

The magnetic elements may also be used in other types of equipment, particularly sporting equipment, such as those shown in FIGS. 6 and 7. FIG. 6 shows the plates inset into a piece of snow equipment, such as a snowboard, snowskate or other snow-gliding equipment. FIG. 7 shows the plates inset into a mountain board. This type of connection may also be used for other types of connections when holding a piece of board type equipment to the foot of a user.

Many features have been listed with particular configurations, options, and embodiments. Any one or more of the features described may be added to or combined with any of the other embodiments or other standard devices to create alternate combinations and embodiments.

Although the examples given include many specificities, they are intended as illustrative of only a few embodiments of the invention. Other embodiments and modifications will, no doubt, occur to those skilled in the art. For example, the embodiment shown has two magnets used in each housing. In alternate embodiments, fewer or more magnets may be used in each housing and more than one housing could be used in each shoe. Further variations could include an embodiment with one or more housings located in only one of the pair of shoes. This would potentially be useful to allow the user to hold the board to one foot, while leaving the other foot free to propel the board or for other purposes. Thus, the examples given should only be interpreted as illustrations of some of the preferred embodiments of the invention, and the full scope of the invention should be determined by the appended claims and their legal equivalents.

What is claimed is:

1. A skateboard for use with a shoe having magnetic properties, the skateboard comprising:
a skateboard deck,
a ferrous first plate attached to said skateboard deck proximate a front edge of said skateboard deck,
and a second ferrous plate attached to said skateboard deck proximate a back edge of said skateboard.

2. The skateboard of claim 1, wherein said first plate is elongated and located on a horizontal portion of said skateboard deck adjacent an upturned portion of said skateboard deck.

3. The skateboard of claim 1, wherein said first plate is located with an edge between 0 and 5 inches from a back edge of the skateboard deck.

4. The skateboard of claim 1, wherein said second plate is round and located on an upturned portion of said skateboard deck.

5. The skateboard of claim 1, wherein said second plate is located with an edge between 0 and 10 inches from a front edge of the skateboard deck.

6. The skateboard of claim 1, wherein said first plate is elongated and located on a horizontal portion of said skateboard deck adjacent a first upturned portion and with an first plate edge between zero and 10 inches from a front edge of the skateboard deck, and wherein said second plate is round and located on a second upturned portion of said skateboard deck with an edge between zero and 5 inches from a rear edge of the skateboard deck.

7. The skateboard of claim 1, wherein said first plate has a width between 1 to 6 inches

8. The skateboard of claim 1, wherein said second plate has a width between 1 to 7 inches and a length between 2 and 18 inches

9. A sole for a shoe used with a skateboard having magnetic properties, the sole comprising:
a flexible sole sized and configured to connect with the shoe,
a sole cavity located within said sole,
a ferrous pole piece sized and configured to fit within said sole cavity and having a magnet cavity located within said ferrous pole piece,
and a magnet located within said magnet cavity,
wherein said ferrous pole piece and magnet are connected with said sole and located at least partially within said cavity.

10. The sole of claim 9, further comprising a base plate attached to said ferrous pole piece.

11. The sole of claim 10, wherein said ferrous pole piece is attached to said base plate with a rivet.

12. The sole of claim 9, wherein said ferrous pole piece is cup-shaped and said magnet is located therein.

13. The sole of claim 9, wherein said magnet is neodymium-iron-boron.

14. The sole of claim 9, further comprising a second ferrous pole piece attached to said base plate and having a second magnet cavity located therein and a second magnet located within said second cavity.

15. The sole of claim 9, wherein said ferrous pole pieces are spaced apart such that a portion of said sole of the shoe may be located between said ferrous pole pieces.

16. The sole of claim 9, further comprising a second shoe having a mirror image configuration to form a pair of shoes.

17. In combination:
a skateboard, comprising:
a skateboard deck,
a ferrous plate attached to said skateboard deck,
a shoe, comprising:
a shoe upper,
a shoe sole,
a sole cavity located within said sole,
a ferrous pole piece sized and configured to fit within said sole cavity and having a magnet cavity located within said ferrous pole piece,
and a magnet located within said magnet cavity,
wherein said ferrous pole piece and magnet are connected with said sole and located at least partially within said cavity,
wherein said magnet and ferrous pole piece providing sufficient attraction with said ferrous plate to keep said skateboard proximate said shoe during normal aerial maneuvers.

18. The combination of claim 17, wherein said ferrous plate is a first plate attached to said skateboard deck proximate a front edge of said skateboard deck, and further comprising a second ferrous plate attached to said skateboard deck proximate a back edge of said skateboard deck.

19. The combination of claim 17, further comprising a base plate attached to said ferrous pole piece.

20. The combination of claim 19, wherein said ferrous pole piece is attached to said base plate with a rivet.
